(19) United States
(12) Patent Application Publication
(10) Pub. No.: US 2012/0130761 A1
(43) Pub. Date: May 24, 2012

(54) VENDOR-CENTRIC ITINERANT CART

(76) Inventor: Deepti Mohan, Bangalore (IN)

(21) Appl. No.: 13/387,755

(22) PCT Filed: Jun. 7, 2010
(86) PCT No.: PCT/IN2010/000373

§ 371 Date: Jan. 30, 2012

(30) Foreign Application Priority Data
Aug. 7, 2009 (IN) 1882/CHE/2009

(51) Int. Cl. G06Q 50/10; G06Q 10/08

(52) U.S. Cl. 705/7.12

(57) ABSTRACT

This invention proposes a systematic approach to itinerant selling wherein a vendor-centric view is adopted for inventory control, authenticated access to loading and vending of retail items within local regulatory frameworks. By providing precise information of every item, location and time at which the item was sold, and quantity sold, this invention is able to maintain detailed transactional logs, which can be used later for establishing compliance and resolving disputes. By providing means to identify unique carts, assign unique codes for every action performed in the system and addressing operational difficulties such as need to relocate from congested places of business, this invention provides an end-to-end solution for authorized itinerant sales. Additionally, per-item analysis is available by using unique identifiers on the items and enabling location-determination of the cart and its inventory for maintaining appropriate checks and balances in the system.

### FIELD OF THE INVENTION

This invention relates to a vendor-centric itinerant cart for dispensing a variety of items.

### DISCUSSION OF PRIOR ART

Present methods for selling products on carts are deficient in supporting the sale of products in compliance with state or national level laws. Solutions offering such compliance are often ineffective, utilize electricity and impose several restrictions including, but not limited to, confining the area in which a cart is allowed to move or sell. There are three categories of carts that merit attention in order to compare the present invention. The first kind of cart is very basic and has a known structure including a platform on wheels, a plurality of bars to support the top and a hood or a canopy to cover the content of the cart. The cart may additionally have a box to hold the products and may be manually operated. The second category of carts is very similar to the first but have an engine to propel the cart, alongside an electricity generator on board for temperature control and special storage facilities for the products. The third kind serves as retail outlets for known brands of clothing, food and other retail items. Such carts are more ubiquitous in their presence outside major shopping centers and public areas and a majority of such carts require power for completing the sale and need to be stationed at a fixed place.

Most of the carts described above are fairly stationary during their time of operation or vending and come with an additional restriction of not being able to easily adhere to regulatory requirements of the law. This inability results in vendors and hawkers selling at congested places besides enabling unauthorized sales at times not controlled easily by legal authorities. Besides the vendors selling in congested/unauthorized areas, such a model complicates the auditing process for law-enforcement agencies. Tracking carts that are either purposefully or in error vending at unauthorized locations or beyond selling hours enforced is a complex task for municipal and police authorities.

US20090078702 describes a Trackable Cart wherein structural definition of the cart in question allow loading, unloading and assigning of a unique identifier to the cart. This invention is mainly applied to collecting trash and provides features for rollout and the inclusion of RFID tags to identify the cart.

CA2228026 describes a Storage and Dispensable cart wherein the main purpose of the cart is to dispense medical supplies. Besides introducing safety features including latches, the cart also comes equipped with a computer preprogrammed with patient information. The computer is a centralized access-control means to only allow access to certain shelves in the cart to avoid unauthorized use of medical supplies. This invention does not address a variety of retail items or introduce the notion of communicating amongst a network of carts.

JP2007106557 describes a Medical supply tracking system in . . . wherein the purpose of the cart is for medical supplies disbursement. By utilizing IC tags, several medical supplies are stocked at various physical locations. This invention introduces the notion of alarms to enable detecting the shelf life of the medical supplies to the concerned authorities.

U.S. Pat. No. 6,374,748 describes a Tracking cart system wherein carts move along an electric guide-rail. The primary object of this invention is to retrofit guided carts into places that don't have facilities of lines being laid out, beforehand. The contribution of this patent is mostly in the structural effects and being able to optimally utilize power and enable tracking carts.

JP2008013330 describes a Carriage cart running track whose primary objective is in providing rails along which carts can run and JP4250380 describes a Tracking device whose primary objective is to track unmanned carts in real-time. This invention takes visual cues from image processors that are a part of television units that are incorporated with the device. The stored content is then replayed for manning the carts effectively. This invention does not address individual inventory tracking or regulating sales from carts.

US20090251286 describes Object tracking devices and methods disclose the use of RFID tags to track a plurality of devices. This invention has to do with the tracking device itself and not with the entire cart that is used for vending retail items, as disclosed in our invention.

US2009230644 describes a Utility Cart used to store and supply repair parts and equipment. Besides introducing the idea of even-sized compartments that act as holding areas, the position adjustment enabled in this invention makes room for dynamically configuring these areas to accommodate differently shaped tools.

WO2009132295 describes a PAYLOAD AWARE MEDICAL CART, SYSTEM AND METHOD with a per-item ID-tag and centralized control on the medical supplies in the cart, with strict access-control. This invention introduces the notion of inventory control on a per-item basis but does not talk about managing a network of such carts, recording obstructions or detecting the location of the cart, thereby being different from our disclosure.

U.S. Pat. No. 7,418,311 describes a Portable dispensing device for refreshments and sundries, which retrofit a vending portion into a golf-cart. Snack-holding bins are proposed in this invention to house inventory, which is similarly sized. An inventory management system is proposed for centralized billing and control over supply and demand of various products on sale through this dispensing device or cart. While this invention further proposes means to wirelessly communicate with a control center there is no mention of regulating the cart or its sales to legal requirements, which is integral to our invention.

U.S. Pat. No. 7,118,036 describes a Mobile Inventory Management System proposes the use of per-cart readers to identify RFID tags on individual items and communicate with a central data-store to obtain information about the items. Additionally, the location of the carts are also known in this invention and communicated. This invention does not have any proposal for obstruction detection or networking a set of carts for enforcing legal limits of retailing and also does not provide the security features of authorized loading and vending that our invention does.

KR20030024525 describes a Cart Information Device where the primary objective of the invention is to enable consumers to check prices on items by means of an information display panel mounted at the cart. This invention does not deal with itinerant selling.

U.S. Pat. No. 7,199,709 describes a Cart Fleet Management System where hand-operated carts constructed for carrying luggage incorporate an integral distance sensor to measure how far the cart has traveled, interfacing with a unit that receives the distance measurements. Scheduling carts for use, maintenance and optimizing distance traveled by the cart are the primary objectives of this invention and not so much legal selling of retail goods.

ES2144944 describes a Motor vehicle adapted for the itinerant sale of ice-creams, cold drinks, baked flour dough and other foods where the cart provides thermal regulation for its contents and inventory. Additionally, an internal lighting system, an advertising music unit and alternative sources of power including batteries and generators are proposed in this invention.

DE10150223 describes a Shopping trolley or transport cart, has cover for closing container on top of trolley chassis describes a collapsible structure for a cart, to enable quick assembly and dis-assembly.

NZ508604 describes A hotel mini-bar vending machine with a central control means to keep track of product usage wherein one or more mini-bar vending machines are able to keep a per-item inventory control and further communicate via WAP, with a central system. This invention does not address itinerant selling, the need for authorized access to load and vend items or obstruction identification features, which are central to our invention.

Key objectives of this invention are to overcome the deficiencies of the prior-art and propose a cart, propelled manually or by means of an engine, and to provide a system of checks and balances to ensure authorized sales from authorized locations at authorized times. The cart also presents means to log the movement of the cart and sales therein, in order to resolve conflicts between authorities and the vendor. The structure of the cart in the present invention is designed to enable lawful selling by means of introducing compartments and slots that can be loaded only by authorized entities. By using a faceplate and a combination of springs alongside properly demarcated access to the loading and selling portions of the cart, the structure of the cart is enabled for mobile vending. The invention introduces tracking of inventory and sales at the item level enabled by recording the item code, which is unique to every category of item. Further security features such as a unique identifier for the cart, vendor authentication and identification and administrative demarcations via authentication and identification, are unique to this invention. The invention further allows for co-ordination and communication with other entities by means of co-ordination actions and codes. Obstruction recording is another critical aspect of this invention that provides needed information to prove or refute traffic obstruction during itinerant selling.

### SUMMARY OF THE INVENTION

In this invention a vendor-centric system for itinerant selling is proposed, including a cart, propelled manually or by means of an engine, that can be used to sell authorized inventory with mechanisms to control the location and time of sale by legal authorities comprising several features including means to enable authorized use of the cart, enabling only authenticated users to load items for vending and to dispense loaded items for selling, means to limit selling only authorized items, means to track inventory and sales to ensure authorized selling within legal limits, means to enable security features by using unique identifiers to track the cart, and vendors and administrators that are operating the cart, means to enable co-ordination and communication amongst carts and with administrative authorities, means to enable obstruction recording to prove or refute traffic obstruction caused during itinerant selling, and means to plan, control, and operate a network of such carts.

Another object of this invention is to propose a cart used for itinerant selling, propelled manually or by means of an engine, that can be used to sell authorized inventory with mechanisms to control the location and time of sale by legal authorities comprising structural support to load the cart with the inventory, means to track time, location information, a way to initialize parameters pertaining to one or more unique identifiers and standardized inventory, features to enable co-ordination and communication amongst individual carts and with authorities and features to enable obstruction recording to prove or refute traffic obstruction caused during itinerant selling. This invention overcomes the problem of unauthorized selling for any product that can be sold on a cart—cooked food, fresh foods, pulses and grains, spices, produce, drinks, milk & milk produce, bakery & deli, meat, sanitary napkins & diapers, medicines, cosmetics, frozen Food, plastic/disposable items, daily use items, soaps, cleaning supplies, candy, furniture, utensils, kitchen tools, computers, car systems, navigation systems, refrigerators, cooking ranges, chimneys, vacuum cleaners, microwaves, cell phones, music & video (sale), music & video (rental), clothes, bedding, bath products, newspapers & magazines, stationary, toys, etc. It does so without relying upon an electricity connection to complete or track the sale.

The different components that make this invention are an unique identifier for each cart, a self contained cart structure with loading and vending facilities, a standardized set of inventory that is to be sold, a device capable of identifying the cart and vendor, a device capable of computing and tracking inventory, a coordination device to communicate information (such as inventory, current location, current time, etc.) to other entities, and a device to record traffic conditions in case of obstruction caused by cart. In addition, a device to time (and date) stamp receipts and products upon sale and a device to identify or determine the current location are needed for the invention to work. A printer to print receipts is optional.

The invention's ability to communicate information (such as inventory, current location, current time, etc.) enables a central management entity to plan, control, and operate a network of such carts based on a map of locations, time/location/product restrictions, and demand by location for products.

### BRIEF DESCRIPTION OF DRAWINGS

FIG. 1A describes a Cart structure with vending side in view;

FIG. 1B describes a Cart structure with narrow side in view;

FIG. 1C describes a Cart structure with loading side in view;

FIG. 1D describes a Cart structure with compartments and slots in view. Far right door open to show the interior view;

FIG. 2 describes Internals of a slot with a faceplate and spring mechanism to ensure items can be loaded only from the loading end, not from the vending end;

FIG. 3 describes a Pre-packaged product;

FIG. 4 describes Information captured, stored, and transmitted for each sale;

FIG. 5 describes an Item list showing how the item numbers are assigned;

FIG. 6 describes an Action code description and associated information;

FIG. 7 describes a List received from trusted source of product. List comprises of item number and quantity received;

FIG. 8 shows the flow of information and product from trusted source to customer. The diagram also shows the devices used in the embodiment described in this invention;

FIG. 9 shows the planning of a network of carts described in this invention. Key components are a location map and demand map;

FIG. 10 shows the external features of the obstruction recording device. The side views, top view, and bottom view are shown;

FIG. 11 shows the placement of the obstruction recording device on the cart. The video recording device is placed in the slot and rotated to capture the traffic conditions; and

FIG. 12 shows the operation of a network of carts described in this invention. Different components such as location map, demand map, plan, real-time inventory from the network, and list of open locations are some of the components for operation.

### DETAILED DESCRIPTION OF PREFERRED EMBODIMENTS

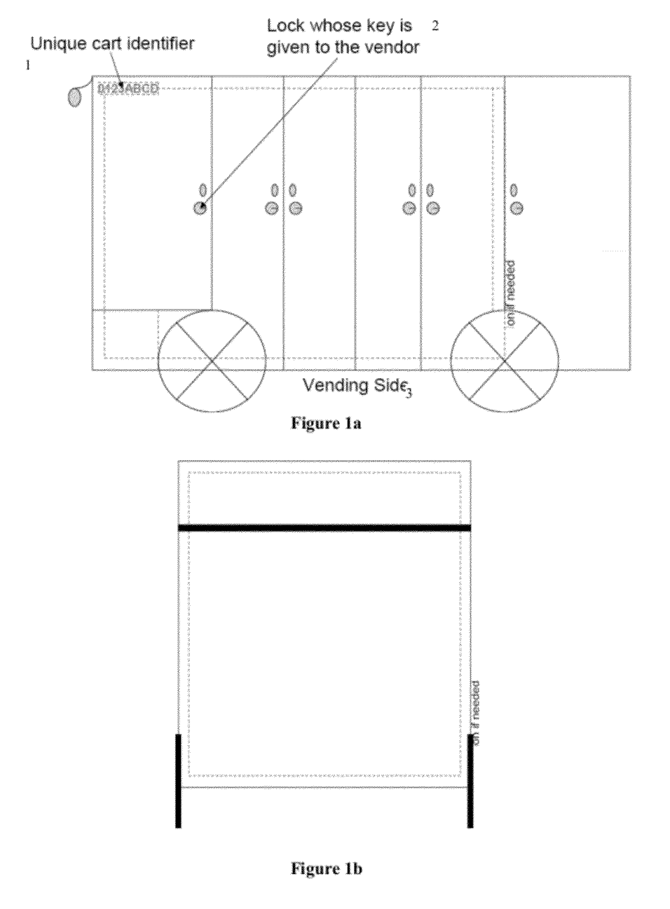

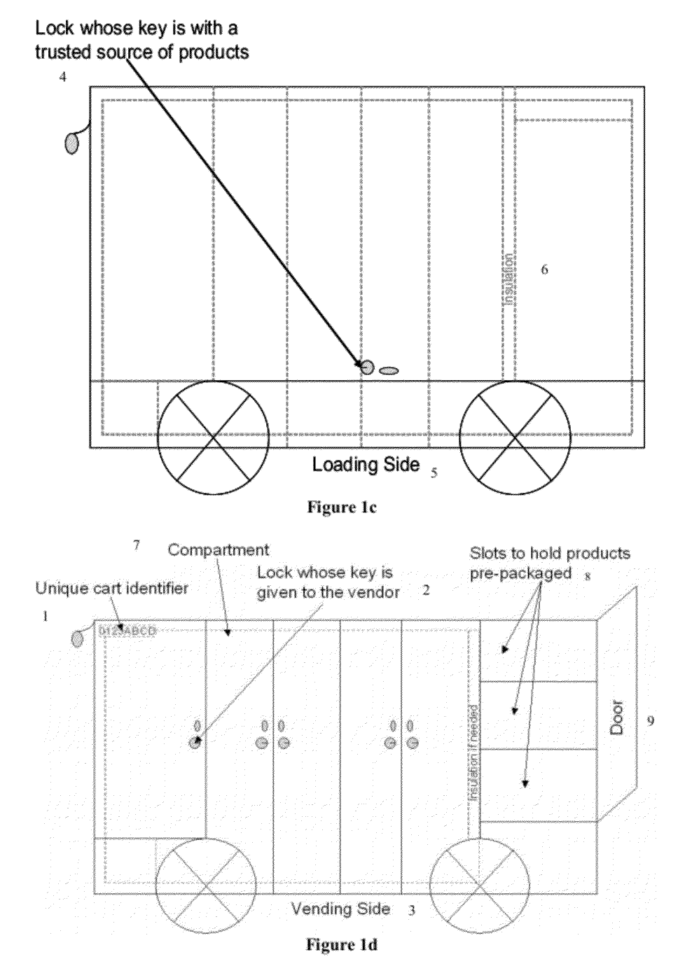

The invention relies upon a unique identifier 1 assigned to each cart. The cart structure will have an outer wall made of any material—high impact polyethylene, fiberboard, aluminum, steel, fiber glass, wood, or any other material—that can support the structure. Based on the material used, the unique identifier could be imprinted, embedded during molding, or etched in, as shown in FIG. 1A. This number should be unique with or without built-in intelligence. The outer wall should be attached to a maneuvering system and other accessories. Additional supporting rods or structures may be used. Inside the outer wall and surrounding the insulation, if one is used, is the inner wall that provides support for compartment and slots described later. Like the outer wall, inner wall may be made of any material with enough strength to support the weight of the products to be sold.

The cart structure can be in any shape. It must be enclosed to hold the product to be sold. FIGS. 1A, 1B, 1C, and 1D show a cuboid shape. The top, bottom, and the narrower sides are solid. The lateral sides have doors. One side is the vending side 3 (see FIGS. 1A & 1D) that provides access to the hawker/vendor to take out the products for sale. The other side is the loading door 5 (see FIG. 1C) through which the cart is loaded with standardized products described later. The vending door and loading doors have unique locks to control access. The vendor door lock key 2 is given to the vendor, while the loading door key 4 is given to a trusted source that supplies products in compliance to the law. The trusted source will be referred to as the administrator of the cart. The structure may have thermal insulation 6 and doors 9 may have additional features and insulation to maintain optimal temperature of the product, if needed. As mentioned earlier, the cart structure may be in any shape. Alternatively, the vending doors may be on the top side of a cuboid shape; while one of the lateral sides is the loading side, the other could be solid. In addition, the cart may have other facilities and provisions to hold garbage, packaging, etc. Additionally, a solenoid latching device can be incorporated in this cart for enhancing security.

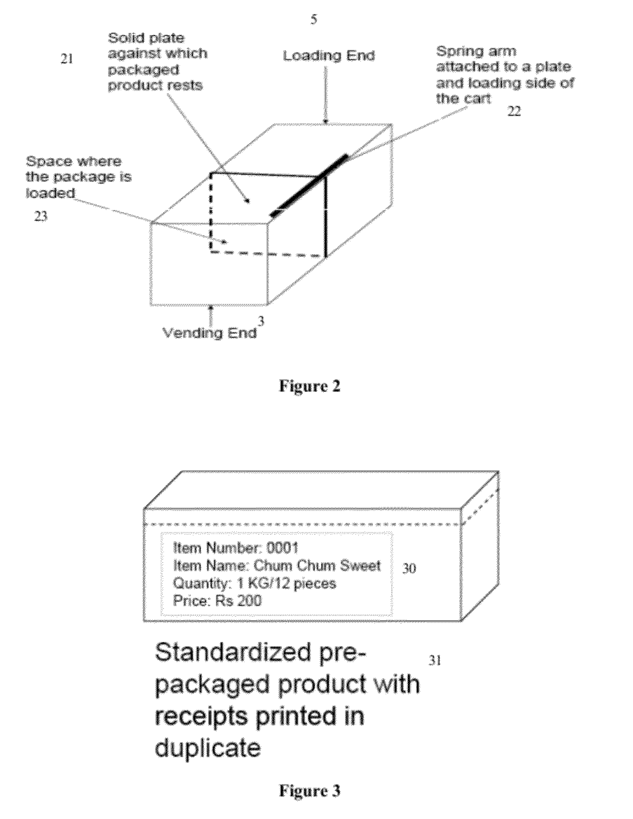

The loading space has compartments and slots to hold packaged products 8 of defined size and quantity. See FIG. 1D. The vendor 3 should be able to take out a packaged product but should not be able to load it back into the cart. The interior has to be divided into several compartments 7. These compartments should be the size of the product to be held. Each compartment should further be divided into slots that can hold individual packaging containing the product. FIG. 2 shows the end of each slot should be fitted with a spring 22 and plate 21. When packaged products are loaded, the spring gets compressed completely and the plate touches the packaging, as shown in FIG. 2. As products are taken out, the remaining products are pushed forward to occupy the space 23 created and the spring expands. The vendor shouldn't be able to load product back to the cart. Distance between slots is just enough to hold the packaging. The spring and plate assembly could be made removable by administrator for ease of loading. However, the vendor should not be able to remove the assembly at any time. The spring and plate assembly should be functional while the loading door is shut and the vending function could be performed. Each compartment is secured with a door that has a lock fitted. The other sides of the structure should be solid, just like the bottom. While it is feasible to combine different items in one slot or even completely eliminate compartments and slots resulting in one large slot, it is not a preferred embodiment as finding the product requested will be difficult and may provide gaps where unauthorized products could be placed.

The inventory to be sold on the cart should be standardized in terms of product, quantity, and packaging, as shown in FIG. 5. For example, a food cart should have packaged boxes with pre-determined quantities ready to be dispensed. An item number 52 should be assigned to a product type and quantity combination 51. The item number should not have any intelligence about the product built into it. Optionally, a receipt 31 in duplicate can be printed on the packaging with item name, code, quantity, and price 30. If receipt is not pre-printed, a receipt printer will be needed. FIG. 3 shows an example of product standardization and packaging. For the instance of the invention described here, the printer will not be used to keep the overall cost of the cart low. At the time of sale, these pre-printed receipts will be time and date stamped and one of the copies will be lifted by the vendor. The other copy remains on the packaging and is customer's receipt. The packaging has to fit snuggly between the plate of the spring and the other end of the cart. The strength provided by the packaging should be more than the pressure applied by the spring to ensure the packaging and the product don't get crushed.

Radio Frequency Identification (RFID), Ultrasound Identification (UID), or bar code technology could be optionally used to electronically identify, and to sense the movement or presence of standardized products in the cart structure. Appropriate shielding and preventive steps would be required to ensure proper detection. However, benefits of such technologies should be weighed against the cost they add. For the embodiment described here, such technologies will not be used to keep the cost low.

An electronic device that can be mapped to the cart structure is the next component described. Hence forth, this device will be referred to as the identity tracking device. This device should be capable of storing the cart's unique identifier, verified vendor name, verified address, verified identity information, and a mobile phone number that is uniquely assigned to the cart. This device provides access to two roles. The first is the administrator who has password controlled access and rights to update this information in the device. The other is the vendor who is assigned a password. The vendor is able to query the device for this information but is not allowed to change or update it in any manner. This device should be either wireless enabled or interfaced with a wireless communication device. This device can be CDMA, GSM, or 3G enabled. GPRS connectivity is optional. In any case, the number assigned to the wireless communication device should be the one stored in the identity tracking device mapped to the cart.

A second electronic device is needed to track inventory. Hence forth, this device will be referred to as the inventory tracking device. This device can be the same device as the identity tracking device mentioned earlier or a separate device. In either case, the inventory information should be accessible to the identity tracking device. The inventory tracking device should also implement the admin and vendor roles and access control, should be able to store the items that can be sold on the cart, should store the beginning/sold/on board inventory, should be capable of receiving inventory numbers from a computer or another device, and should provide a way to query existing inventory. The next two components are standard devices, already available in the market. The first is a device to stamp pre-printed receipts with current time and date upon sale of the product by the vendor. This device is not needed, if a printer is used to print receipts with current time and date. The second is a device to determine the current location. This device is capable of identifying the current location in terms of the GPS coordinates, cell ID, or any other means. Hence forth, this device will be referred to as the location sensing device. If GPS enabled device is carried in the cart structure, it should track the current location several times in a minute. This device should be interfaced with the identity tracking device. The identity tracking, inventory tracking, and location and time tracking devices will be collectively referred to as tracking devices in this document.

In addition, the identity tracking device should be able to perform certain key functions. These functions are reading the current and updated inventory from the inventory tracking device, and the location, time and date from the location sensing device on board the cart. This electronic device should also provide the capability to the vendor to update the item and quantity sold, as part of the completion of the sale process. If a receipt printer is used, this electronic device should be interfaced with the printer to print receipts. The identity tracking device should also be able to combine inventory and number of products sold by item number with location, time and date information collected from the location sensing device, notify inventory and location to other entities, and show the current location to the vendor.

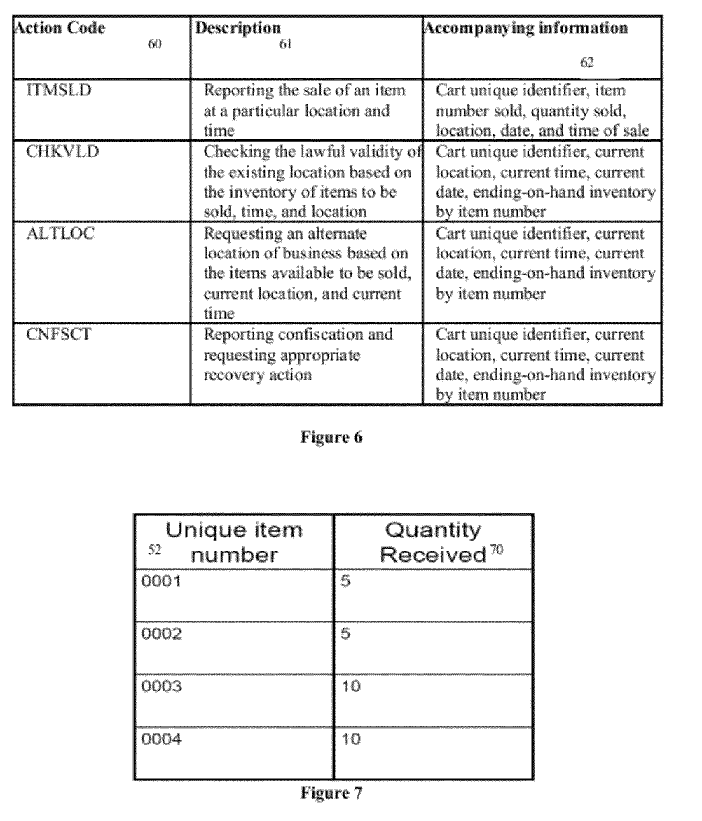

The last component is an electronic device that lets the vendor coordinate with other entities. This device provides the ability to provide precise location, time, date, and inventory information to other entities. This enables the vendor to check if his current location is in violation of any law, to request for an alternate location, or to notify if his cart and inventory get confiscated. Hence forth, this device will be referred to as the coordination device. This device can be the same device as the identity or inventory tracking device mentioned earlier or a separate device. In either case, the capabilities of coordination device should be accessible to the identity tracking device. The coordination device should also implement the admin and vendor roles and access control. The features of the coordination device can be seen as actions that the vendor can request another entity. Each action 60 should have a code and the related information 61 & 62. For example, confiscation can be identified with CNFSCT followed by the cart unique identifier, inventory, time, date, and location information. The other entity can decode this and respond with appropriate action. FIG. 6 shows action codes, descriptions, and associated information to be sent.

Again, to keep the cost low, the same electronic device will be used for identity and inventory tracking, and coordination devices. Any device ranging from an ordinary cell phone with minimum of 256 KB volatile and non-volatile memory, capable of running J2ME and having a battery life of at least 8 hours; to a personal digital assistant having a complete operating system with memory in several mega-bytes to a central processing unit (CPU) based device to a fully loaded computer with memory in giga-bytes can be used. Also, the device should be Bluetooth enabled and must have a built-in or external video camera. Again, to keep the cost low, an ordinary cell phone capable of running J2ME, Bluetooth, and built-in video recorder will be used. For communication purposes, the Short Messaging Service (SMS) will be used. The SMS can be over GSM, CDMA, or 3G. Other forms of communication, such GPRS and Cell Broadcast Service (CBS) can be used. However, to keep the cost low, SMS will be used for communication over GSM. The Bluetooth device name for the cell phone should be unique and associated to the cell number.

The first step is to build a non-volatile record store in the cell phone. Two user accounts with unique and secret passwords need to be built. The first is the administrator. The second is for the vendor. The passwords are shared with the respective users. The administrator initializes the record store with the cart unique identifier, verified vendor name, verified address, verified identity information, and the mobile phone number that is uniquely assigned to the cell. The administrator also initializes the record store with the item number list that the cart can sell. Only the administrator has the ability to update these fields in the record store.

The cell phone is also enabled to be paired up over Bluetooth with a computer. The computer belongs to the trusted source providing products to be sold and holds the total inventory available to be sold. The administrator will set the beginning-on-hand inventory for all item numbers to zero (0), assuming initially the cart doesn't hold any inventory. At the time of loading the cart with products, the list of item numbers along with the quantities loaded will be sent to the administrator user identification over Bluetooth from the computer. The administrator will update the record store with the quantities loaded. The item number 52, quantity pair (see FIG. 7) for each item received will be stored as received inventory 70 in the record store, as shown in FIG. 7. The administrator will also ensure that items numbers and quantities written to the record store are actually loaded on the cart by the trusted source of products. The administrator will unlock the loading door and these products have to be loaded in the slots described earlier in the cart structure.

As mentioned earlier, the cell phone will also be used as a device to manage inventory. The record store by now has the standardized item list with quantities available to be sold. For each of the item number on this list, a corresponding total number sold and ending on hand records are added to the record store. The vendor user account can access but not update the cart identification, vendor identification, and the beginning-on-hand inventory information.

A GPS device will be used for identifying location. The cell phone is also interfaced with this GPS device. The GPS device can be a data logger available in the market with Bluetooth connectivity. The cell phone will utilize the Bluetooth connection to read the present location, time, and date. The vendor is provided with an interface to enter the quantity sold for each item loaded on the cart. To process and complete a sale, the vendor has to unlock the right door on the cart, dispense the requested item, time (and date) stamp the receipt with the time stamping device, lift the duplicate receipt, and enter the quantity sold in the cell phone. Once the vendor performs these actions, the cell phone reads the current location, time, and date from the GPS data logger and adds a single record for each item number with location, time, date, and quantity sold. Simultaneously, sold and ending on hand inventories are calculated and updated in the record store.

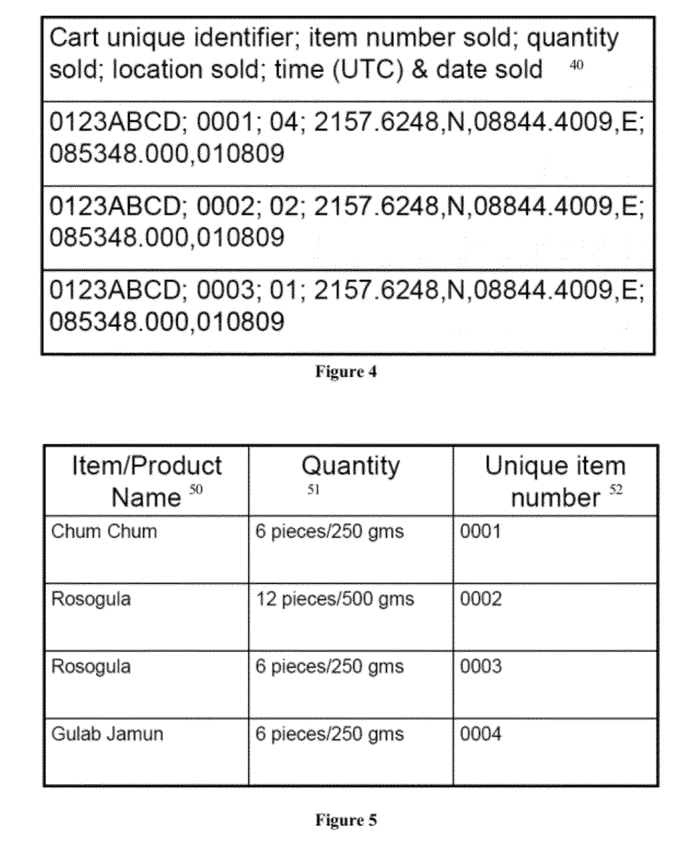

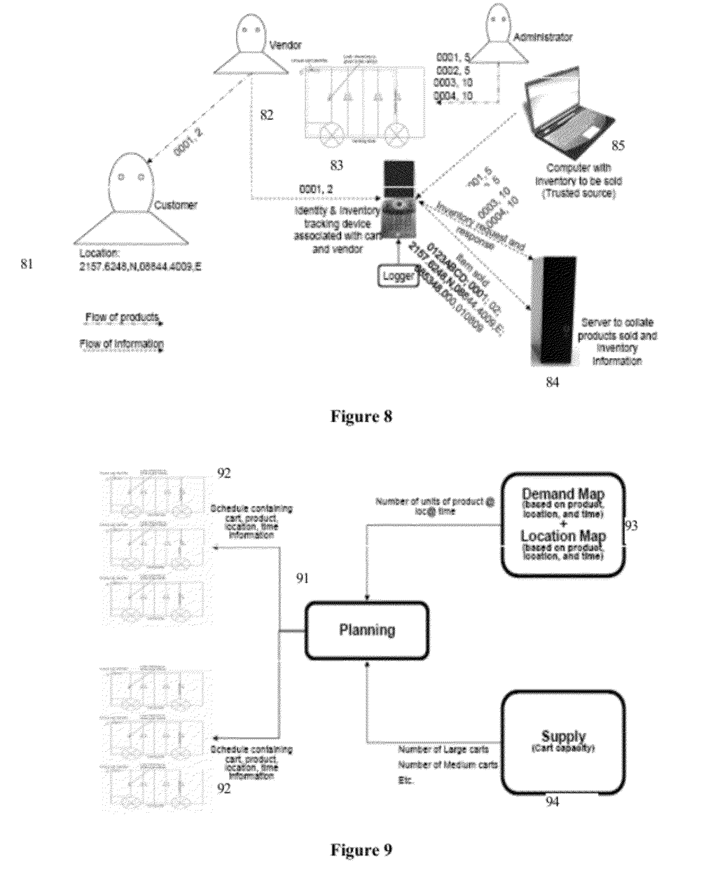

As shown in FIG. 8, on a periodic basis or on demand, the cell phone sends the items sold data to another server, where it is collated with the rest of the history and stored. FIG. 8 shows the flow of product and information from trusted source 85 to customer 81. The action code (ITMSLD, see FIG. 6 for action codes), cart unique identifier, item number sold, quantity sold, location, date, and time 82 are sent in a SMS message. The server 84 on the receiving end parses the message using a gateway and stores the information under the unique identifier 1 for the cart. The information sent is shown in FIG. 4. The cell phone provides the ability to send location and time combined with the right action code in a SMS message to request position validation, inform about confiscation, or request an alternate location.

FIG. 4 shows how the information pertaining to an item sold at a location at particular time can be obtained by combining the item number, location, time, and date data, as the vendor enters the sale in the device. The item sold, time, and date information from the receipt can be combined with location, time, and date log on the location sensing device, using the time and date as the key, to reconcile with the entries made by the vendor and to validate the product, location, time, and date data 40. In either case, the precise information of item, location, time, and date at which the item was sold, and quantity is available. This information, along with the item code list provided by the trusted provider of goods, can be used to establish compliance to the location, product, and time restrictions placed by the municipal and police authorities. Historical information can be presented to resolve disputes. Alarms can be introduced to alert the vendors if a cart is found to be breaching legal limits. Only vendors with authorized access are allowed to turn off alarms, using their discretion. The vendor sells only legally allowed products and is able to establish if he is in compliance with the time and location restrictions.

An obstruction recording device makes audio and visual recording with cart identification, vendor identification, inventory, location, and time information available as evidence to prove or refute obstruction. The obstruction recording device provides the ability to video record the current traffic condition. This device is mounted at a location where 360 degree view of traffic condition can be recorded by the vendor. FIG. 11 shows a possible location for mounting the obstruction recording device 100. The recording 110 could be done at the request of authorities, if needed. The video recording, cart unique identifier, inventory, time, date, and location information can be sent to or consolidated by another entity. The other entity stores the information for later use.

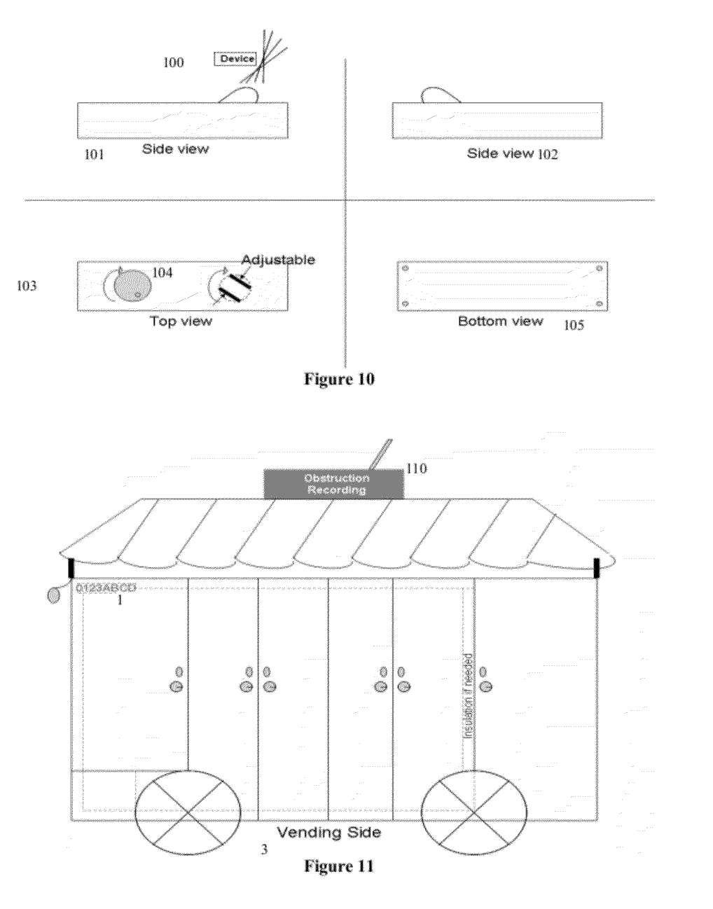

As shown in FIG. 10, obstruction recording device 100 has a platform with facility to support the cell phone vertically or inclined at an angle to capture the 360 degree view of the traffic condition. This platform is controlled by a rotating knob 104 (see top view in FIG. 10) through a gear assembly inside the obstruction recording device box. When this knob is rotated, it, in turn, rotates the platform for the cell phone to capture the traffic condition.

There are three possible ways to enable the video recording and reporting an obstruction. First, the video camera is controlled within the J2ME environment. The cart identification, vendor identification, location, inventory, time, date, and video recording could be sent to another entity through multi-media service or Bluetooth. In case of multi media service, GPRS connectivity will be required. In both cases, multi media service and Bluetooth, a cell phone that provides video capture facility from within J2ME applications would be required. Typically, such cell phones are costlier and often get in the range of smart phones.

Second, the built-in video camera application could be used for recording and sent over GPRS in an e-mail message. The receiving entity can identify the location from the GPS logs in the location sensing device based on the time and date stamp on the video recording. Similarly, based on the cell phone number embedded in the e-mail message, the cart and vendor identification can be determined. The other entity can also determine the inventory at time of obstruction by sending a request to the identity tracking device to respond with current inventory.

The third option is to use the built-in video camera application and send the recording over Bluetooth to another entity. The receiving entity can identify the location from the GPS logs in the location sensing device based on the time and date stamp on the video recording. Similarly, based on the Bluetooth identity of the cell phone sending the video, the cart and vendor identification can be determined. While the cart identification, vendor identification, obstruction recording, and location are collected and stored, the inventory might not be available under this option. The third option is the most economical option, since it avoids usage of GPRS and requires only a low cost cell phone. Both first and second options described above are more expensive, hence the third option will be used.

As shown in FIG. 9, the availability of current inventory information and items sold information enables the coordination and planning of a network of such carts. Planning and coordination could be based on locations and demands that could be serviced in compliance with restrictions imposed by the authorities. The inventory information could be used to replenish and place carts. The sale information could be used to forecast demand and to plan placements of carts at locations.

The item number, location, date, and time describe or characterize not only a sale, but also can be used to describe or characterize inventory and demand. A network of such carts can be planned, controlled, and operated, based on characterization of demand, inventory, and sale by item, location, time, and date. FIG. 9 shows one potential way of planning 91 a network of such carts. The planning is based on a location map and a demand map 93. The location map is a listing of location, product, time, and date combinations in and out of compliance with the restrictions imposed by the authorities. The demand map is a listing of the quantities of the products that could be potentially sold at particular locations at particular times and dates. The other input of planning is the number of carts, size, and capacity the network may have 94. The output of planning could be a schedule containing cart ID, products it should carry at what locations with dates and times 92.

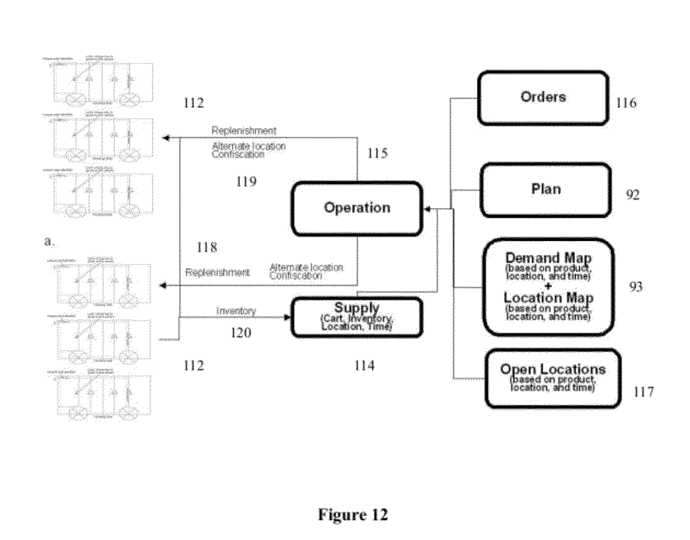

FIG. 12 shows one potential way of controlling the operation 115 of a network of such carts. The inputs can be the orders 116 received from customers, planned schedules 92 for cart placement with recommended quantities of products 112, demand and location maps 93 as descried earlier, and a list of open locations 117 where carts could be relocated. Replenishments 118, alternate locations 119, and sequencing of locations could be planned based on these inputs and the current inventories 120 in the network. Additionally, a system-level map could be implemented for enabling location and demand maps 93. The system-level map could use Graphical Information Systems (GIS). The tracking device could be interfaced with the maps, making the maps a part of the overall planning 91 and operation 115 of the network of carts.

### Example 1

### Selling Sweets

Sweets come in various shapes, sizes, and consistencies. Some also have syrup or liquid. Some may be semi-solid, while others may be solid. Unique item numbers are created for a combination of the sweet type and quantity. The quantity may vary from single piece to a larger number packed together to a particular weight packed. The sweets can be packaged in plastic or card board boxes. A pre-printed receipt in duplicate is pasted to the packaging. The receipt shows the item number, item name, quantity, and prices.

These boxes or packages fit in the slots in each compartment of the cart. The administrator will authenticate in the cell phone. For the first time, the administrator will also set the beginning-on-hand inventory for all item numbers to zero (0), assuming initially the cart doesn't hold any inventory. At the time of loading the cart with sweets, the list of item numbers along with the quantities loaded will be sent to the administrator user identification over Bluetooth from the computer. He/she will also receive the goods. At this time, the item number and quantity pairs are updated in the record store. The administrator will also ensure that item numbers and quantities written to the record store are actually loaded on the cart by the trusted source of products. The administrator will unlock the loading door and these products will be loaded in the slots in the cart structure.

Next, the vendor authenticates and signs-in in the cell phone. To process and complete a sale, the vendor has to unlock the right door on the cart, dispense the requested item, time (and date) stamp the receipt with the time stamping device, lift the duplicate receipt, and enter the quantity sold in the cell phone. Once the vendor performs these actions, the cell phone reads the current location, date, and time from the GPS data logger and adds a single record for each item number with location, date, time, and quantity sold. Simultaneously, sold and ending on hand inventories are calculated and updated in the record store.

On a periodic basis or on demand, the cell phone sends the items sold data to another server, where it is collated with the rest of the history and stored. The action code (ITMSLD), cart unique identifier, item number sold, quantity sold, location, date, and time are sent in a SMS message. The server on the receiving end parses the message using a gateway and stores the information under the unique identifier for the cart.

The vendor can also check if he is violating a no-hawking zone, is stepping out of the tehbazari (vending site) limits, selling an item not allowed by law, or selling at a time not allowed by law. This function can be performed by going to the “check validity option” on the cell phone. Clicking on this sends the cart unique identifier, current location, date, time, inventory on the cart, and action code (CHKVLD) to another entity, such as a call center like facility. The other entity checks the action code, and checks the validity of coordinates by mapping it in a GPS software and cross checks the location against all valid locations. It also checks if selling items in the inventory is allowed by law at the position and at the time in the message. Alternatively, the validity could be checked against the location map described earlier. Once the validity of the location is determined, the other entity sends an SMS with original position coordinates, item numbers, time, date, and a yes/no outcome to the cell phone number for the cart identified by the unique identifier.

Similarly, if the vendor or the authorities determine that the current location of the cart is causing congestion, the vendor can request another location by going to the “request another location” option. Clicking on this sends the cart unique identifier, current location, date, time, inventory on the cart, and action code (ALTLOC) to the other entity. The other entity checks the action code and looks for another valid location based on restrictions imposed by law, the inventory available, and the current time. Once another valid location is found, the other entity sends an SMS with original position coordinates and the alternate location coordinates along with location name to the cell phone number for the cart identified by the unique identifier. Once the vendor receives the SMS, he/she can relocate to this new location without loss of business. He can make sure he is at the recommended location by going to the “show current location” option. This will show the GPS coordinates that can be compared against the recommended coordinates.

If the vendor's cart gets confiscated for some reason, he/she may go to the “inform confiscation” and select it. Clicking on this sends the cart unique identifier, current location, date, time, inventory on the cart, and action code (CNFSCT) to another entity. The other entity checks the action code and follows up with authorities to get the inventory and cart out quickly. It also reconciles the inventory on the cart with the inventory reported in the SMS message. Reports on the location, time, date, and inventory onboard the cart can be provided, incase of disputes between the vendor/hawker and the authorities, police or municipal.

Often traffic congestion may be caused or authorities may allege so during itinerant selling. To handle such situations, the vendor voluntarily or at the request of the authorities may record the traffic conditions using the obstruction recording device. He may go to in-built video recording facility and start the video camera. The vendor should put the cell phone on the obstruction recording device shown in FIGS. 10 and 11, and rotate the knob to record the traffic condition. At the end of the recording, the video clip is stored and sent to another entity. If needed, the other entity determines the location from the GPRS data logger logs based on the date and time of the video, and the cart and vendor identification based on cell number and Bluetooth identity. It stores the video clip, location of obstruction, cart identification, and vendor identification for future use.

### Example 2

### Selling Microwaves

Microwaves are available in various sizes, brands, and features. Based on the brand, size, and features, the microwaves are assigned an item number. In this case, the quantity is always one (1). The item number uniquely identifies a particular kind of microwave in a single quantity. The item number, in this case, always identifies one and only one uniquely identifiable microwave. So a one liter microwave with model number 123456 and brand XYZ will have a unique item number. The microwaves can be packaged in plastic or card board boxes; or, may not be packaged at all. A pre-printed receipt in duplicate is pasted to the packaging or the microwave itself. The receipt shows the item number, item name, quantity, and prices.

These boxes, packages, or microwaves themselves fit in the slots in each compartment of the cart. The administrator will authenticate in the cell phone. For the first time, the administrator will also set the beginning-on-hand inventory for all item numbers to zero (0), assuming initially the cart doesn't hold any inventory. At the time of loading the cart with microwaves, the list of item numbers along with the quantities loaded will be sent to the administrator user identification over Bluetooth from the computer. He/she will also receive the goods. At this time, the item number and quantity pairs are updated in the record store. The administrator will also ensure that items numbers and quantities written to the record store are actually loaded on the cart by the trusted source of products. The administrator will unlock the loading door and these products have to be loaded in the slots in the cart structure. The rest of the description is the same as shown for sweets above.

### Example 3

### Selling Beverages

There are two ways of handling beverages. The first is where the beverage is pre-packaged in a container and is ready to be consumed. The handling of this type of beverages is exactly similar to the handling of sweets, microwaves, or any other item. Thus this kind will not be described here.

The second is where a hot beverage is in a separate dispenser and poured in at the time of sale. The handling of this kind of beverage is slightly different. The beverage will be contained in a sealed dispenser with an opening to fill a glass or a cup. This container should have a tamper proof seal and should be supplied by the trusted source of products at the time of loading the cart. Along with the container, the trusted source also provides cups or glasses that are loaded in the slots in the cart structure described earlier. The vendor takes out these cups exactly the same way he/she takes out pre-packaged products. The cups and glasses also have a pre-printed receipt in duplicate. The receipt shows the item number, item name, quantity, and prices.

These glasses fit in the slots in each compartment of the cart. The administrator will authenticate in the cell phone. For the first time, the administrator will also set the beginning-on-hand inventory for all item numbers to zero (0), assuming initially the cart doesn't hold any inventory. The unique item number, in this case, is assigned to the pair of the beverage type and quantity (for example, 250 ml of tea is a unique item number). At the time of loading the cart with the beverages, the list of item numbers along with the number of glasses or cups loaded will be sent to the administrator user identification over Bluetooth from the computer. At this time, the item number and quantity pairs are updated in the record store. The administrator will also ensure that items numbers and quantities written to the record store are actually loaded on the cart by the trusted source of products. The administrator will unlock the loading door and glasses or cups will be loaded in the slots in the cart structure. He/she will also receive the beverages in tamper proof containers. The containers will be placed on the top surface of the cart.

Next, the vendor authenticates and signs-in in the cell phone. To process and complete a sale, the vendor has to unlock the right door on the cart, take out a glass or cup, time (and date) stamp the receipt with the time stamping device, lift the duplicate receipt, pour the beverage from the tamper proof container, and enter the quantity sold in the cell phone. Once the vendor takes these actions, the cell phone reads the current location, date, and time from the GPS data logger and adds a single record for each item number with location, date, time, and quantity sold. Simultaneously, sold and ending on hand inventories are calculated and updated in the record store. The rest of the description is the same as shown for sweets above.

1. A vendor-centric system for itinerant selling including a cart, propelled manually or by means of an engine, that can be used to sell authorized inventory with mechanisms to control the location and time of sale by legal authorities comprising:
a. Means to enable authorized use of the cart, enabling authenticated users to load items for vending and to dispense loaded items for selling;
b. Means to limit selling only authorized items;
c. Means to track inventory and sales to ensure authorized selling within legal limits;
d. Means to enable security features by using unique identifiers to track the cart, and vendors and administrators operating the cart;
e. Means to enable co-ordination and communication amongst carts and with administrative authorities;
f. Means to enable obstruction recording to prove or refute obstruction caused during itinerant selling; and
g. Means to plan, control, and operate a network of such carts.

2. A system of claim 1 wherein means to enable authorized use of the cart includes:
a. Means to load the cart by authorized users; and
b. Means to vend from the cart at authorized times and places by authorized users.

3. A system of claim 2 wherein the means to load further comprises:
a. Means to identify and pair the tracking device with one or more trusted sources providing items to be sold;
b. Means for the administrator to receive the list of item numbers along with quantities;
c. Means to update the tracking device's record store with quantities received;
d. Means to load through the cart's loading door inventory from one or more trusted sources;
e. Means to populate the tracking device with quantities of items loaded; and
f. Means to unlock the loading door for the products to be loaded.

4. A system of claim 2 wherein the means to vend further comprises:
a. Means to authenticate in the tracking device with vendor identification information;
b. Means to process a sale by a vendor which further comprises:
i. Unlocking the cart's door;
ii. Dispensing the inventory items along with a receipt indicating the time and other parameters of the sale; and
iii. Recording a plurality of sales and transmitting information as necessary by the device.

5. A system of claim 1 wherein means to limit selling only authorized items includes:
a. Means to standardize inventory to be sold
b. Means to ensure only administrator can load inventory.

6. A system of claim 5 wherein the standardized inventory to be sold on the cart are:
a. Standardized with respect to product, quantity and packaging; and
b. Have unique identifiers associated with them.

7. A system of claim 5 whose interior can be divided into several compartments sized according to the product being enclosed that can be further divided into slots to hold individual pieces including a spring and plate at the end of each slot or whose interior utilizes another mechanism to ensure that vendors are able to take out the products but unable to load the products (due to the function of the spring or of another mechanism).

8. A system of claim 1 wherein means to track inventory and sales to ensure authorized selling within legal limits further comprises:
a. Means to store the cart's unique identifier, vendor name, address, identity information and contact numbers assigned to the cart;
b. Means to provide authenticated access to the administrators and vendors with different permissions and update privileges;
c. Means to enable vendors to query the device for information populated by the administrator;
d. Means to enable wireless communication with the cart;
e. Means to enter the quantity sold wherein the tracking device reads the current location, time, and date further comprises:
i. Communicating item, quantity, location, time, date, and other information over CDMA, GSM or 3G interfaces; and
ii. Interfacing with location sensing device, such as a GPRS logger or cell ID.
f. Means to track the inventory loaded, sold and remaining on the cart;
g. Means to receive inventory numbers from one or more computers or other external devices;
h. Means to identify the location, time and date information collected from a location sensing device, such as a GPS device or cell ID;
i. Means to enable vendors and hawkers to update the inventory numbers based on what is sold and to query the existing inventory;
j. Means to track product, location, and time parameters of inventory sold and remaining; and
k. Means to report.

9. A system of claim 8 having means to report further comprising:
a. Means to enable vendors to indicate to other entities the inventory sold by item number and the location, date, and time of sale;

10. A system of claim 1 wherein means to track inventory and sales to ensure authorized selling within legal limits involves the use of a GPS device to identify the location.

11. A system of claim 1 wherein the means to enable security features by using unique identifiers to track the cart, and vendors and administrators operating the cart further comprises:
a. Means to assign a unique cart identifier that has alpha-numeric characters with or without built-in intelligence;
b. Means to build administrator and vendor user accounts in a tracking device with a non-volatile record store with unique and secret passwords;
c. Means to standardize the inventory to be sold with respect to product, quantity and packaging;
d. Means to initialize the tracking device's record store;
e. Means to identify and store the vendor name, address, information and mobile phone number;
f. Means to load the appropriate identifiers for the cart and the vendors including contact information and permissions; and
g. Means to initialize a tracking device's record store with item number list that the cart can sell and interface with an external computer/device that may be used to send the list to administrator.

12. A system of claim 1 wherein the means to enable co-ordination and communication amongst carts and with administrative authorities further comprises actions that the vendor can request another entity and that have codes associated with them including:
a. Means to report sale of an item by sending a code for reporting the sale of the item at a particular location and time followed by cart unique identifier, item number sold, quantity sold, location, date, and time of sale;
b. Means to check the legal validity of a location of business by sending a code for checking lawful validity of the existing location based on the inventory of items to be sold, time and location followed by cart unique identifier, current location, current time, and current ending-on-hand inventory by item number;
c. Means to request an alternate location of business by sending a code for requesting an alternate location based on the items available to be sold, current location and time followed by cart unique identifier, current location, current time, and current ending-on-hand inventory by item number; and
d. Means to report cart confiscation by sending a code for reporting confiscation and requesting appropriate recovery action followed by cart unique identifier, current location, current time, and current ending-on-hand inventory by item number.

13. A system of claim 1 with means to enable obstruction recording to prove or refute obstruction caused during itinerant selling comprising:
a. An obstruction recording device with a platform and facility to support the built in or external camera of the tracking device vertically or inclined at an angle to capture the 360 degree view of the traffic condition;
b. A rotating knob used to control the platform through a gear assembly inside the obstruction recording device box such that when this knob is rotated, it, in turn, rotates the platform for the built in or external camera of the tracking device or the use of another mechanism to capture the traffic condition; and
c. Send the recording to administrative authorities along with identification and date and time information

14. A system of claim 1 wherein the means to plan, control, and operate a network of such carts further comprises:
a. Means to define a location map containing a listing of location, product, time, and date combinations in and out of compliance with the restrictions imposed by the legal authorities;
b. Means to define a demand map containing a listing of the quantities of the products that could be potentially sold at particular locations at particular times and dates;
c. Means to plan based on location map, demand map, number of carts, size of cart, and other parameters of the network;
d. Means to specify the output of planning to include a schedule containing cart ID, products it should carry at what locations with dates and times;
e. Means to operate based on orders received, planning schedule, list of open locations, demand map, and location map; and
f. Means to control replenishment and placement of carts at alternate locations based on current inventories, demand map, location map, and list of open locations.

15. A system of claim 14 wherein Geographical Information Systems (GIS) are used to implement location and demand maps

16. A system of claim 1 wherein the device used for tracking and co-ordination could be a cellular phone with minimum of 256 KB volatile and non-volatile memory, capable of running J2ME, Bluetooth enabled, built-in camera, and having a battery life of at least 8 hours.

17. A system of claim 1 wherein the device used for tracking and co-ordination could be personal digital assistant, smart phone, Central Processing Unit (CPU) based device, or packaged personal computer with ability to communicate over Bluetooth or another form of network and having a built-in or external video camera.

18. A system of claim 1 wherein the device used for tracking and co-ordination could communicate using the Short Messaging Service (SMS) wherein the SMS can be over GSM, CDMA, or 3G.

19. A system of claim 1 wherein the device used for tracking and co-ordination could communicate using other forms of communication, such as GPRS and Cell Broadcast Service (CBS).

20. A system of claim 1 wherein the cart structure can assume any shape and encloses the products to be sold comprising:
a. One or more doors with access control;
b. Separated access for vending and loading with unique access mechanisms;
c. May have a solenoid or another kind of latching device;
d. Authenticated alarm systems for authorized vendors; and
e. Means to ensure safe access to the inventory with protection against external factors including heat and humidity.

21. A system of claim 1 wherein the cart structure has walls made of any material including high impact polyethylene, fiberboard, aluminum, steel, fiber glass or wood.

22. A system of claim 1 wherein the cart or its contents can be identified using any of:
a. RFID tags;
b. UID tags; and
c. Barcodes.

23. A system of claim 1 wherein the cart's outer wall could be attached to a maneuvering system and other accessories.

24. A system of claim 1 wherein the inventory's packaging is resilient to damage and pressure applied by the spring.

25. A system of claim 1 with means to print receipts such that receipts can be printed on the packaging or separately indicating the item name, code, quantity and price.

26. A system of claim 1 wherein the devices on the cart can communicate with a central server to update information pertaining to the inventory, products sold, the vendor or other parameters related to the cart.

27. A system of claim 1 wherein one embodiment entails the sale of sweets from the cart comprising means to identify various sweets of different sizes, consistencies and quantities.

28. A system of claim 1 wherein one embodiment entails the sale of microwaves where the quantities of the items are always discrete numbers.

29. A system of claim 1 wherein one embodiment entails the sale of beverages at various temperatures, dispensed by various quantities.

30. A system of claim 1 wherein the inventories that can be sold on the cart includes cooked food, fresh foods, pulses and grains, spices, produce, drinks, milk & milk produce, bakery & deli, meat, sanitary napkins & diapers, medicines, cosmetics, frozen food, plastic/disposable items, daily use items, soaps, cleaning supplies, candy, furniture, utensils, kitchen tools, computers, car systems, navigation systems, refrigerators, cooking ranges, chimneys, vacuum cleaners, microwaves, cell phones, music & video (sale), music & video (rental), clothes, bedding, bath products, newspapers & magazines, stationary, toys, etc.
